(19) United States
(12) Patent Application Publication
(10) Pub. No.: US 2025/0142011 A1
(43) Pub. Date: May 1, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: MASAHIRO KAJIMOTO, Chiba (JP); KENTA USAMI, Ibaraki (JP)

(21) Appl. No.: 18/926,046

(22) Filed: Oct. 24, 2024

(30) Foreign Application Priority Data
Oct. 26, 2023 (JP) 2023-183848

(51) Int. Cl. H04N 1/32; H04N 1/00

(52) U.S. Cl. CPC H04N 1/32128; H04N 1/00212; H04N 1/00225; H04N 1/00244; H04N 2201/0094; H04N 2201/3228

(57) ABSTRACT

An image processing apparatus includes a scan unit configured to scan a document image and generate image data, an acceptance unit configured to accept setting of a condition to generate a summary based on the image data, and a transmission unit configured to transmit the generated image data and information indicating the set condition, wherein the summary generated based on the transmitted information is posted to a channel on a chat service.

### BACKGROUND

### Field

The present disclosure relates to an image processing apparatus, an image processing method, and a storage medium.

### DESCRIPTION OF THE RELATED ART

Japanese Patent Application Laid-Open No. 2021-078084 discusses an image processing apparatus transmitting image data generated by scanning a document image to a chat server that provides a chat service.

According to Japanese Patent Application Laid-Open No. 2021-078084, the scanned data can be uploaded to a talk room of the chat service. However, if the content of the uploaded file is unable to be determined from its filename, the file is to be opened once to check its content, which can be time-consuming.

### SUMMARY

The present disclosure is directed to enabling easy checking of the content of a file when the file is uploaded to a chat service.

According to an aspect of the present disclosure, an image processing apparatus includes a scan unit configured to scan a document image and generate image data, an acceptance unit configured to accept setting of a condition to generate a summary based on the image data, and a transmission unit configured to transmit the generated image data and information indicating the set condition, wherein the summary generated based on the transmitted information is posted to a channel on a chat service.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration according to an exemplary embodiment of the present disclosure.

FIG. 2 is a diagram illustrating an example of a hardware configuration of an image processing apparatus.

FIG. 3 is a diagram illustrating an example of a hardware configuration of a mobile terminal.

FIG. 4 is a diagram illustrating an example of a hardware configuration of a message application server.

FIG. 5 is a diagram illustrating an example of a hardware configuration of a character recognition server.

FIG. 6 is a diagram illustrating an example of a hardware configuration of a large language model server.

FIG. 7 is a diagram illustrating an example of a home screen displayed on an operation unit of the image processing apparatus.

FIG. 8 is a diagram illustrating an example of a sequence where the image processing apparatus transmits a file generated by scanning and a thumbnail image to the message application server.

FIG. 9 is a flowchart illustrating an example of processing where the image processing apparatus transmits the file generated by scanning and the thumbnail image to the message application server.

FIGS. 10A to 10D are diagrams illustrating examples of screens of a scan to chat function according to a first exemplary embodiment.

FIG. 11 is a diagram illustrating an example of a setting registration screen.

FIG. 12 is a diagram illustrating an example of a message screen of a message application according to the first exemplary embodiment.

FIG. 13 is a diagram illustrating an example of a sequence where an image processing apparatus transmits a file generated by scanning and character strings extracted by optical character recognition (OCR) to a message application server.

FIG. 14 is a flowchart illustrating an example of processing where the image processing apparatus transmits the file generated by scanning and the character strings extracted by OCR to the message application server.

FIGS. 15A to 15D are diagrams illustrating examples of screens of a scan to chat function.

FIG. 16 is a diagram illustrating an example of a sequence where an image processing apparatus transmits a file generated by scanning and a summary of character strings extracted by OCR to a message application server.

FIG. 17 is a flowchart illustrating an example of processing where the image processing apparatus transmits the file generated by scanning and the summary of the character strings extracted by OCR to the message application server.

FIGS. 18A to 18E are diagrams illustrating examples of screens of a scan to chat function.

FIG. 19 is a diagram illustrating an example of a message screen of a message application.

### DESCRIPTION OF THE EMBODIMENTS

Exemplary embodiments of the present disclosure will be described below with reference to the drawings. Configurations described in the following exemplary embodiments are just examples, and the present disclosure is not limited to the illustrated configurations.

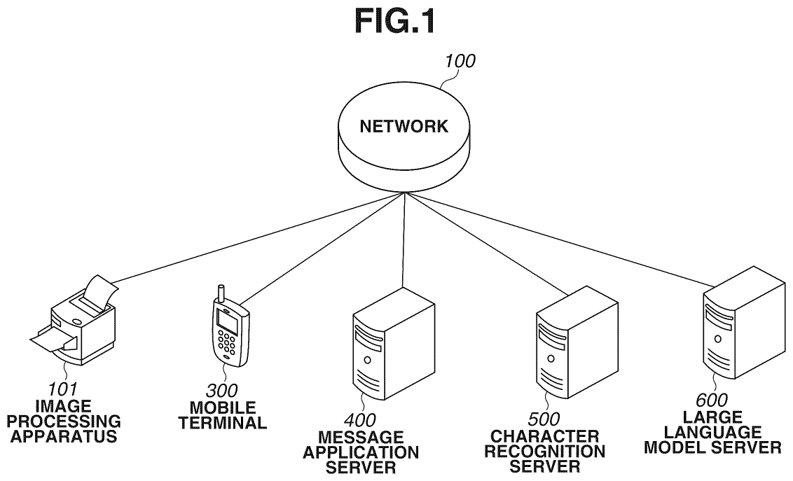

A first exemplary embodiment of the present disclosure will be described below. FIG. 1 is a diagram illustrating an example of a system configuration according to the present exemplary embodiment. The system configuration according to the present exemplary embodiment includes a mobile terminal 300 that is an example of a terminal apparatus, and an image processing apparatus (multifunction peripheral [MFP]) 101 and a message application server 400 that can communicate with the mobile terminal 300 via a network 100. A character recognition server 500 and a large language model server 600 are also connected via the network 100 and can communicate with each other. The message application server 400 receives messages and image data transmitted from the image processing apparatus 101 and the mobile terminal 300. The message application server 400 is a chat server that manages a chat service for displaying the received messages and image data on the mobile terminal 300 and not-illustrated personal computers (PCs). The character recognition server 500 is a server having the function of extracting characters from image data and converting the image data into character data. The large language model server 600 is a server equipped with a language model that generates natural sentences in response to requests made in a natural language, using artificial intelligence. The network 100 according to the present exemplary embodiment may be the Internet or a local area network (LAN). The network 100 may be a wired or wireless network. The message application server 400 may directly receive image data from the image processing apparatus 101. A cloud storage service may receive image data from the image processing apparatus 101, and the message application server 400 may receive the image data from the cloud storage service.

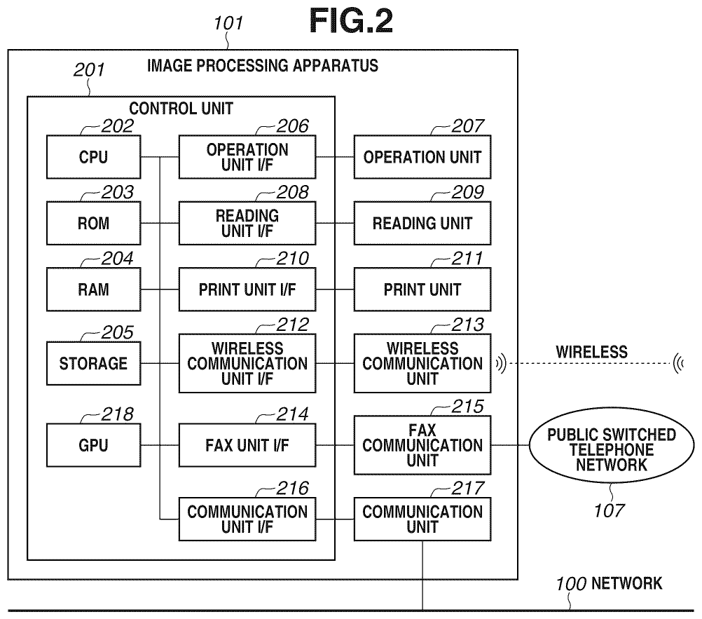

FIG. 2 is a diagram illustrating an example of a hardware configuration of the image processing apparatus 101. The image processing apparatus 101 includes a central processing unit (CPU) 202, a read-only memory (ROM) 203, a random access memory (RAM) 204, a storage 205, an operation unit interface (I/F) 206, an operation unit 207, a reading unit I/F 208, a reading unit 209, a print unit I/F 210, a print unit 211, a wireless communication unit I/F 212, and a wireless communication unit 213. The image processing apparatus 101 also includes a facsimile (FAX) unit I/F 214, a FAX communication unit 215, a communication unit I/F 216, and a communication unit 217.

A control unit 201 including the CPU 202 controls operation of the entire image processing apparatus 101. The CPU 202 reads a control program stored in the ROM 203 or the storage 205 into the RAM 204 and performs various types of control such as reading control and print control. The ROM 203 stores control programs executable by the CPU 202. The ROM 203 also stores a boot program and font data. The RAM 204 is a main storage memory, and is used as a work area and a temporary storage area for loading various control programs stored in the ROM 203 and the storage 205. The storage 205 stores image data, print data, various programs, and various types of setting information. In the present exemplary embodiment, a flash memory is assumed to be used as the storage 205. However, auxiliary storage devices such as a solid-state drive (SSD) and a hard disk drive (HDD) may be used. An embedded MultiMediaCard (eMMC) may be used.

The image processing apparatus 101 according to the present exemplary embodiment is configured so that a single CPU 202 performs various processes illustrated in the flowchart to be described below using a single memory (RAM 204). However, this is not restrictive. For example, a plurality of CPUs, RAMs, ROMs, and storages can cooperate to perform the processes illustrated in the flowchart to be described below. Hardware circuits such as an application-specific integrated circuit (ASIC) and a field-programmable gate array (FPGA) may be used to perform some of the processes.

The operation unit I/F 206 connects the operation unit 207 that includes a display unit, such as a touchscreen, and hardware keys with the control unit 201. The operation unit 207 displays information to the user and detects input from the user.

The reading unit I/F 208 connects the reading unit 209, such as a scanner, with the control unit 201. The reading unit 209 reads a document image, and the CPU 202 converts the image into image data such as binary data. The image data generated based on the image read by the reading unit 209 is transmitted to an external device or printed on a recording sheet. The reading unit 209 includes a not-illustrated conveyance unit such as an auto document feeder (ADF), and can convey a plurality of documents placed on a placement unit and scan the images of the plurality of documents based on a single scan execution instruction given by the user.

The print unit I/F 210 connects the print unit 211, such as a printer, with the control unit 201. The CPU 202 transfers image data (print data) stored in the RAM 204 to the print unit 211 via the print unit I/F 210. The print unit 211 prints an image based on the transferred image data on a recording sheet fed from a feed cassette.

The wireless communication unit I/F 212 is an I/F for controlling the wireless communication unit 213. The wireless communication unit I/F 212 wirelessly connects the control unit 201 with an external wireless device (here, the mobile terminal 300).

The control unit 201 is connected to a Public Switched Telephone Network 107 by controlling the FAX communication unit 215, such as a FAX, using the FAX unit I/F 214. The FAX unit I/F 214 is an I/F for controlling the FAX communication unit 215, and can connect to the Public Switched Telephone Network 107 and control the FAX communication protocol by controlling a FAX communication modem or network control unit (NCU).

The communication unit I/F 216 connects the control unit 201 with the network 100. The communication unit I/F 216 transmits image data and various types of information inside the image processing apparatus 101 to an external apparatus on the network 100 and receives print data and information on the network 100 from an information processing apparatus on the network 100 via the communication unit 217. As a method for transmission and reception via the network 100, email-based transmission and reception or file transmission using other protocols (such as the File Transfer Protocol [FTP], Server Message Block [SMB], and Web Distributed Authoring and Versioning [WebDAV]) can be performed. Image data and various types of setting data can also be transmitted and received over the network 100 through access from the mobile terminal 300, the message application server 400, the character recognition server 500, and the large language model server 600 using Hypertext Transfer Protocol (HTTP) communication.

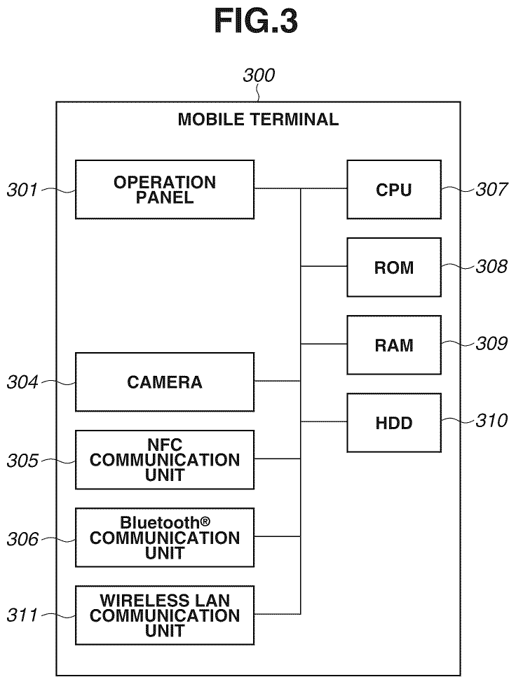

FIG. 3 is a diagram illustrating an example of a hardware configuration of the mobile terminal 300. In the present exemplary embodiment, a device such as a smartphone and a tablet PC is assumed to be used as the mobile terminal 300. However, any other information processing apparatus capable of Wi-Fi communication may be used.

A CPU 307 reads a control program stored in a ROM 308 and performs various types of processing for controlling operation of the mobile terminal 300. The ROM 308 stores control programs. The RAM 309 is used as a temporary storage area such as a main memory and a work area of the CPU 307. An HDD 310 stores various types of data including pictures and electronic documents.

An operation panel 301 has a touchscreen function capable of detecting the user's touch operations, and displays various screens provided by an operating system (OS) and an email transmission application. The operation panel 301 is also used to communicate with the message application server 400 for information check. The user can input desired operation instructions to the mobile terminal 300 by inputting touch operations to the operation panel 301. The mobile terminal 300 includes not-illustrated hardware keys, and the user can input operation instructions to the mobile terminal 300 using the hardware keys.

A camera 304 captures images based on the user's imaging instructions. Pictures captured by the camera 304 are stored in a predetermined area of the HDD 310. Information can be obtained from a Quick Response (QR) code (registered trademark) read by the camera 304, using a program capable of QR code (registered trademark) analysis.

The mobile terminal 300 can exchange data with various peripheral devices via a near-field communication (NFC) communication unit 305, a Bluetooth® communication unit 306, and a wireless LAN communication unit 311. The Bluetooth® communication unit 306 of the mobile terminal 300 may support Bluetooth® Low Energy.

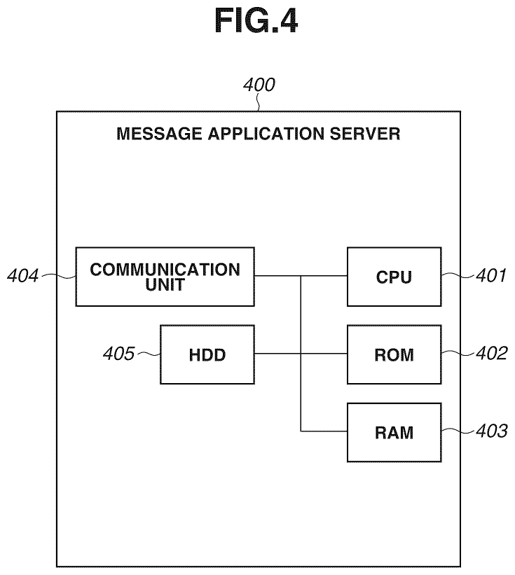

FIG. 4 is a diagram illustrating an example of a hardware configuration of the message application server 400. A CPU 401 reads a control program stored in a ROM 402 and performs various types of processing for controlling operation of the message application server 400. The ROM 402 stores control programs. The RAM 403 is used as a temporary storage area such as a main memory and a work area of the CPU 401. An HDD 405 stores various types of data such as messages, image data, and channel information. The message application server 400 can transmit and receive data to/from various devices such as the mobile terminal 300, the image processing apparatus 101, the character recognition server 500, and the large language model server 600 via a communication unit 404. The communication unit 404 may perform wired communication using the Ethernet (trademark), or wireless communication like Wi-Fi.

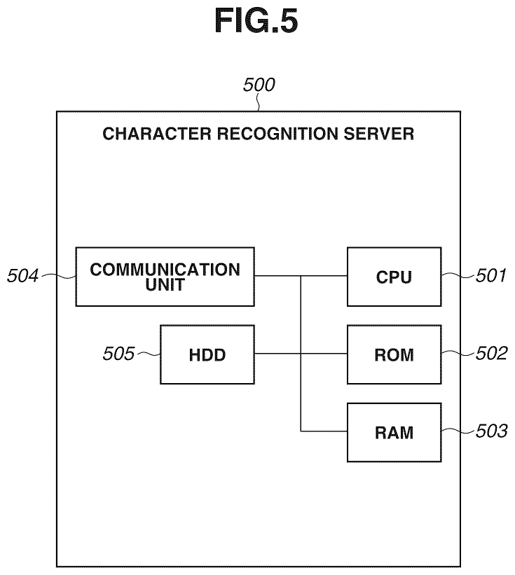

FIG. 5 is a diagram illustrating an example of a hardware configuration of the character recognition server 500. A CPU 501 reads a control program stored in a ROM 502, controls operation of the character recognition server 500, and converts image data into character data in response to a request from the image processing apparatus 101. The ROM 502 stores control programs. A RAM 503 is used as a temporary storage area such as a main memory and a work area of the CPU 501. An HDD 505 stores various types of data such as messages, image data, and channel information. The character recognition server 500 can transmit and receive data to/from various devices such as the mobile terminal 300, the image processing apparatus 101, and the message application server 400 via a communication unit 504.

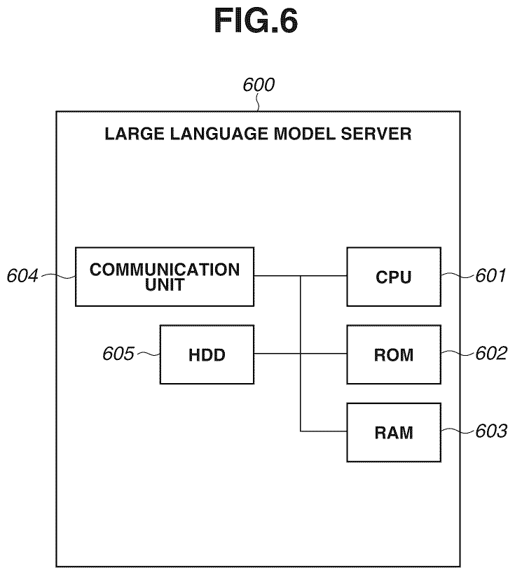

FIG. 6 is a diagram illustrating an example of a hardware configuration of the large language model server 600. A CPU 601 reads a control program stored in the ROM 602, controls the large language model server 600, and processes requests from the image processing apparatus 101, the mobile terminal 300, and the message application server 400. The ROM 602 stores control programs.

A RAM 603 is used as a temporary storage area such as a main memory and a work area of the CPU 601. An HDD 605 stores schedule information about each user. The large language model server 600 can transmit and receive data to/from various devices such as the image processing apparatus 101, the mobile terminal 300, and the message application server 400 via a communication unit 604.

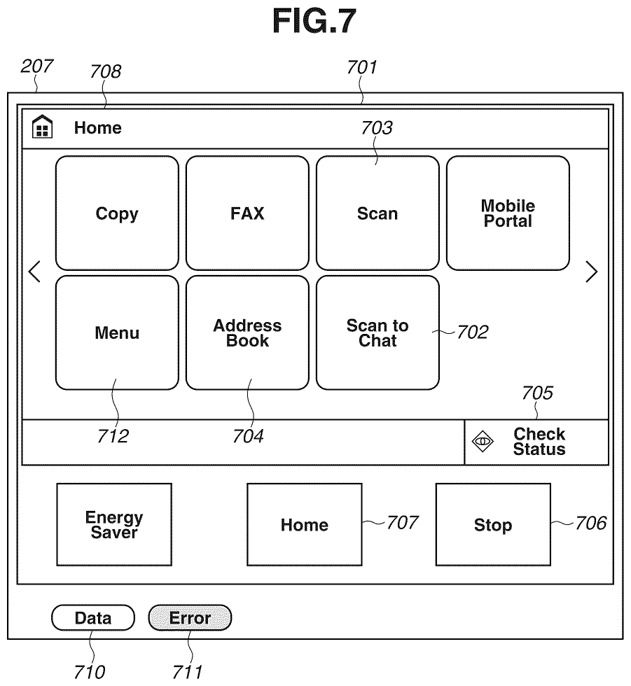

FIG. 7 is a diagram illustrating an example of a home screen displayed on the operation unit 207 of the image processing apparatus 101. The operation unit 207 includes a touchscreen 701 that displays an operation screen, and light-emitting diodes (LEDs) 710 and 711. The touchscreen 701 is an instruction unit, and also functions as an acceptance unit for accepting instructions from the user and a display unit for displaying a screen. The user directly touches the screen displayed on the touchscreen 701 with a finger or an object such as a stylus, and gives instructions to execute various functions based on the displayed screen.

The touchscreen 701 illustrated in FIG. 7 displays a home screen 708. The home screen 708 is the initial screen for giving instructions to execute various functions of the image processing apparatus 101. The home screen 708 is a screen for selecting screen displays to configure various settings for the functions for the image processing apparatus 101 to execute, such as copy, FAX, scan, and media print functions.

A status check button 705 is an object for displaying a screen for checking the state of the image processing apparatus 101 (status check screen). The status check screen, which is not illustrated, can display a transmission history and a job execution history.

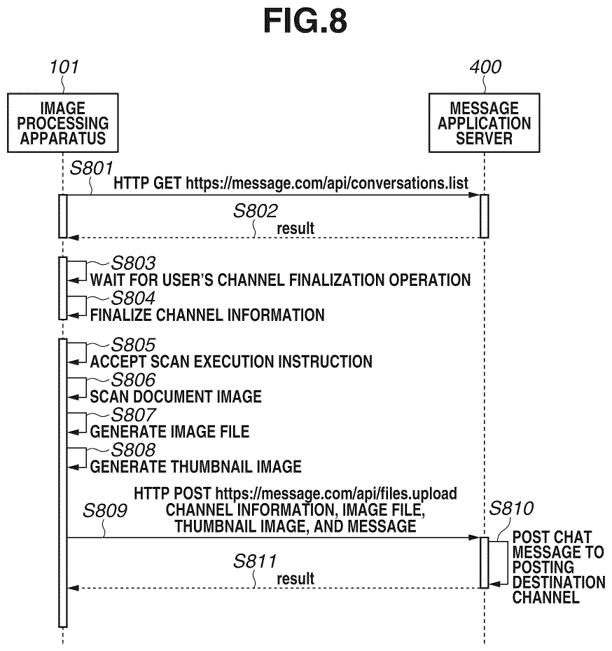

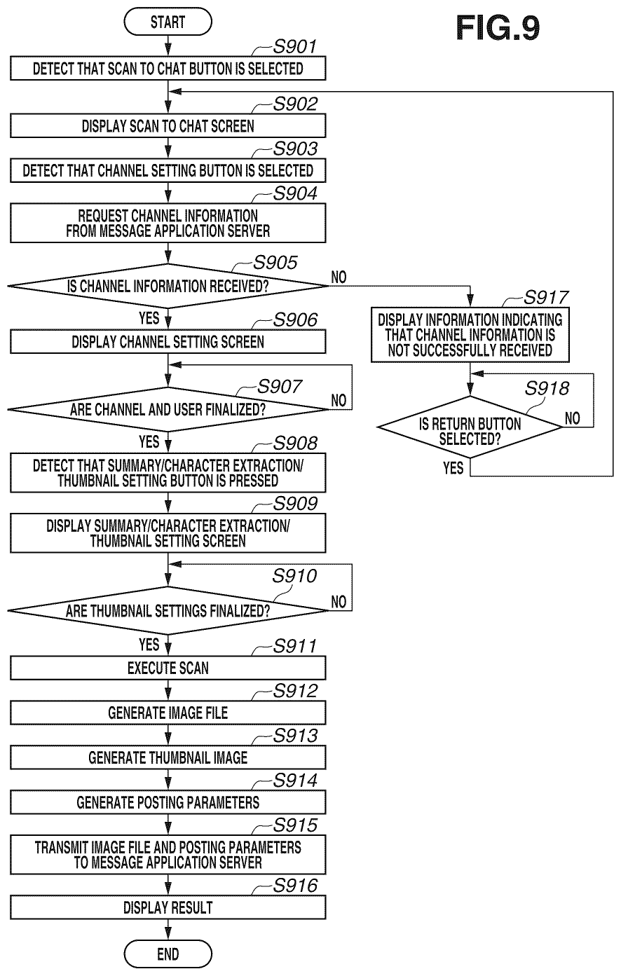

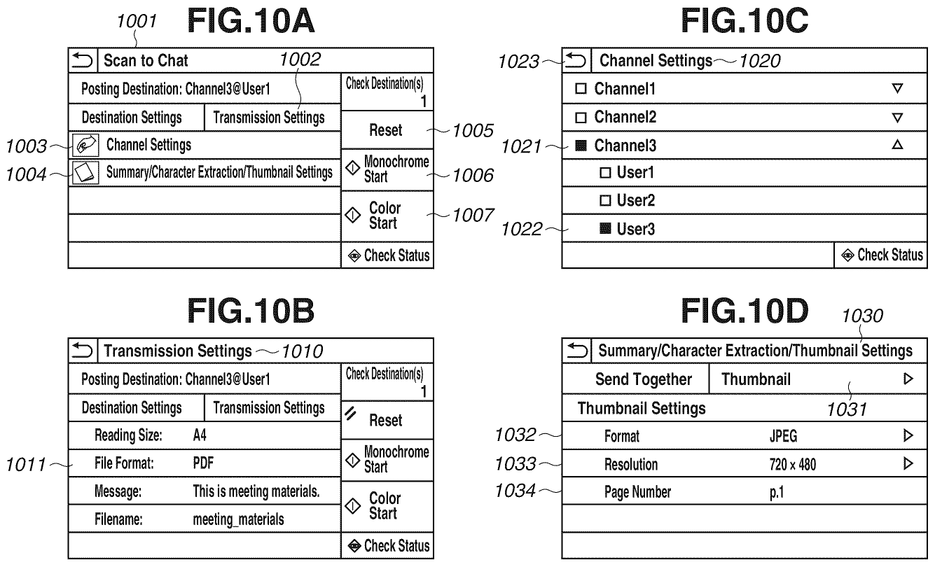

A scan to chat button 702 is an object for displaying a setting screen for scan to chat processing. If the scan to chat button 702 is selected by the user, a scan to chat screen 1001 illustrated in FIG. 10A is displayed on the operation unit 207. The scan to chat processing will be described in detail below with reference to FIGS. 8 and 9.

A scan button 703 is an object for the image processing apparatus 101 to display a scan selection screen (not illustrated). The scan selection screen is a screen for selecting transmission functions such as email transmission (email), file transmission using SMB, FTP, or HTTP, and Internet FAX (I-FAX) transmission. Setting screens for the transmission functions are displayed by touching displayed objects representing the respective transmission functions.

An address book button 704 is an object for displaying an address book screen of the image processing apparatus 101 when selected by the user. The LEDs 710 and 711 are intended to notify the user of the state of the image processing apparatus 101. The LED 710 turns on during reception of an email or during reception or execution of a print job. The LED 711 turns on in the event of an error in the image processing apparatus 101. A stop button 706 is an object for cancelling various operations. This object is constantly displayed on the operation unit 207. A home button 707 is an object for displaying the home screen 708. This object is constantly displayed on the operation unit 207. A menu button 712 is an object for displaying a screen for configuring environmental settings, such as a language setting, and various function settings.

FIG. 8 is a diagram illustrating an example of a sequence where the image processing apparatus 101 transmits a file generated by scanning and a thumbnail image to the message application server 400.

In step S801, the CPU 202 of the image processing apparatus 101 controls the communication unit 217 to request channel information from the message application server 400 by HTTP communication. Specifically, the CPU 202 transmits token information input to the image processing apparatus 101 and information indicating that channel information within a workspace indicated by the token information is requested to the message application server 400. The image processing apparatus 101 may accept input of account information such as a user identifier (ID) and a password for the chat service, obtain token information corresponding to the account information from the message application server 400, and transmit the token information. Transmitting the user ID information (user ID) input to the image processing apparatus 101 to the message application server 400 identifies the information related to the user ID in the workspace. If the reading and writing of user information within the workspace is only authorized for the individual user, the password information (password) corresponding to the user ID information input to the image processing apparatus 101 is further transmitted to the message application server 400 to obtain the authority.

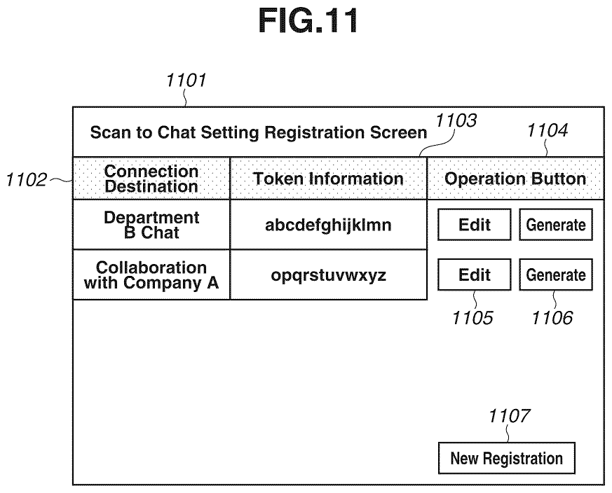

An example of the command to be transmitted here is “HTTP GET https://message.com/api/conversations.list”. The Uniform Resource Locator (URL) “https://message.com/Api/conversations.list” included in this command is the URL for accessing the message application server 400. If token information is transmitted to this URL, the message application server 400 searches for a channel that is linked with the workspace corresponding to the token information and the user. The token information is input by the user via a setting registration screen 1101 of FIG. 11 displayed on the operation unit 207 of the image processing apparatus 101.

As employed herein, a workspace refers to an organization or the like to which a plurality of users belongs in a message application, and may be referred to as a team. A channel is synonymous with a chatroom in the workspace. As employed therein, a chatroom is a mechanism where a plurality of participating users transmits and receives messages to/from each other to interact like a conversation. In the present exemplary embodiment, channels will be described as chatrooms, whereas the mechanism for a plurality of users to transmit and receive messages to interact like a conversion is not limited thereto. Examples may include group chats, rooms, talk rooms, and groups.

In step S802, the CPU 401 of the message application server 400 checks whether the access to the URL is permitted, based on the token information and the user ID received from the image processing apparatus 101 via the communication unit 404. If the access is permitted, the CPU 401 returns the channel information included in the workspace corresponding to the token information to the image processing apparatus 101. The image processing apparatus 101 displays the received channel information on the operation unit 207.

In step S803, the CPU 202 waits for the user's channel finalization operation. In step S804, the channel information is finalized by the user.

In step S805, the CPU 202 of the image processing apparatus 101 accepts a scan execution instruction via the operation unit 207. In addition to the selection of the channel to post to (hereinafter, may be referred to as a posting destination channel), the CPU 202 also accepts scan settings, transmission settings, and thumbnail settings from the user. This sequence deals with a case where “thumbnail” is selected by a send together button 1031 on a summary/character extraction/thumbnail setting screen 1030 (see FIG. 10D).

In step S806, the CPU 202 of the image processing apparatus 101 controls the reading unit 209 to scan a document image based on the scan settings set by the user.

In step S807, the CPU 202 of the image processing apparatus 101 generates an image file of the scanned image in the format set by the scan settings. The scan settings are specified by the user on a not-illustrated scan to chat detailed setting screen. The scan settings may be displayed and set on a transmission setting screen 1010 of FIG. 10B along with the transmission settings.

In step S808, the CPU 202 of the image processing apparatus 101 generates a thumbnail image from the scanned data. The thumbnail image is generated in the format and resolution set on the summary/character extraction/thumbnail setting screen 1030.

In step S809, the CPU 202 of the image processing apparatus 101 transmits the same token information as in step S801, the information about the posting destination channel selected in step S804, and the image file generated in step S807 to the message application server 400 via the communication unit 217. In step S809, the CPU 202 also transmits the thumbnail image generated in step S808 by HTTP communication. An example of the command transmitted here is “HTTP POST https://message.com/api/files.upload”. The file format specified by the user on the scan to chat transmission setting screen 1010 is used here.

In step S810, the CPU 401 of the message application server 400 searches for workspace information registered with the token information received in step S809, and stores the received image file and thumbnail image in association with the channel specified by the channel information. As a result, when the user activates the message application on the mobile terminal 300 and selects the posting destination channel, a screen where the image file and the thumbnail image transmitted from the image processing apparatus 101 are posted appears. The image file and the thumbnail image transmitted are stored in a folder corresponding to the channel selected in step S804. This folder is a folder managed on the chat service as well as a folder on a cloud storage service associated with the chat service.

In step S811, the CPU 401 of the message application server 400 transmits a result corresponding to whether the message is successfully posted to the image processing apparatus 101 as response information by HTTP communication. If the posting is failed, the CPU 202 of the image processing apparatus 101 may display a notification that the posting is failed on the operation unit 207. If the posting is successful, the CPU 202 of the image processing apparatus 101 may display a notification that the posting is successful on the operation unit 207 as well.

FIG. 9 is a flowchart illustrating an example of the scan to chat processing performed by the image processing apparatus 101. The processing of the flowchart in FIG. 9 is performed by the CPU 202 reading a program stored in the ROM 203 into the RAM 204 and executing the program.

In step S901, the CPU 202 detects that the scan to chat button 702 is selected. In step S902, the CPU 202 displays the scan to chat screen 1001 on the touchscreen 701 of the operation unit 207.

The screen displayed when the scan to chat button 702 is selected will now be described with reference to FIG. 10A.

FIG. 10A illustrates an example of the scant to chat screen displayed on the operation unit 207. The scan to chat screen 1001 is displayed on the touchscreen 701 in response to the selection of the scan to chat button 702 displayed on the home screen 708.

If a reset button 1005 is selected on the scan to chat screen 1001, information being set is cleared. Here, channel information, user information, and summary/character extraction/thumbnail settings being set are cleared.

If a monochrome start button 1006 or a color start button 1007 is selected on the scan to chat screen 1001, scan to send processing is started.

FIG. 10B illustrates an example of the transmission setting screen displayed on the operation unit 207.

The transmission setting screen 1010 is displayed when a transmission setting button 1002 is selected on the scan to chat screen 1001. A reading size, file format, message, and filename can be set on this screen. For example, the user can select a file format from file format candidates by selecting a file format button 1011. The user can freely input the message and the filename using a software keyboard.

FIG. 10C illustrates an example of a channel setting screen displayed on the operation unit 207.

A channel setting screen 1020 is displayed when a channel setting button 1003 is selected on the scan to chat screen 1001. The channel setting screen 1020 displays channels based on channel information that the image processing apparatus 101 receives from the message application server 400. A posting destination channel and a mention user can be set on this screen. If a channel button 1021 is selected, the selected channel is set as the posting destination channel. The channel setting screen 1020 may be configured so that more than one channel can be selected. User buttons 1022 are displayed based on the users participating in the channel corresponding to the channel button 1021. Mention users can be set by selecting the user buttons 1022.

If a return button 1023 is selected, the channel selection is stored, and the scan to chat screen 1001 is displayed on the operation unit 207.

FIG. 10D illustrates an example of the summary/character extraction/thumbnail setting screen displayed on the operation unit 207.

The summary/character extraction/thumbnail setting screen 1030 is displayed when a summary/character extraction/thumbnail setting button 1004 is selected on the scan to chat screen 1001.

If the send together button 1031 is selected, which to transmit can be selected among a summary, extracted character strings, and a thumbnail. FIG. 10D illustrates a display in the case of transmitting a thumbnail together with the image file. The summary and extracted character strings will be described in second and third exemplary embodiments.

“None” can be selected to not transmit any of these together with the image file. A plurality of items may be combined.

If a format button 1032 in the thumbnail settings is selected, the format of the thumbnail image can be determined. In the example of FIG. 10D, the Joint Photographic Experts Group (JPEG) format is selected. The format is not limited to JPEG as long as the thumbnail in that format can be previewed on the message application server 400.

If a resolution button 1033 is selected, which resolution to generate the thumbnail image in can be selected. In the example of FIG. 10D, the resolution is 720×480.

If a page number button 1034 is selected, which page of the scanned document to generate a thumbnail image of can be selected. In the example of FIG. 10D, a thumbnail image of the first page is set to be generated.

While FIG. 10D illustrates the setting items format, resolution, and page number, the settings related to a thumbnail image are not limited thereto. For example, an enlarged thumbnail of a part of a page may be generated instead of an entire page. A plurality of thumbnails can be set as appropriate. Scan results may be displayed on the operation unit 207 so that the user can select which part to clip. Thumbnail images can be freely set without departing from the gist of the present disclosure.

Return to the description of the flowchart of FIG. 9.

In step S903, the CPU 202 detects that the channel setting button 1003 is selected. In step S904, the CPU 202 requests channel information from the message application server 400 by HTTP communication, using the token information and the user ID registered in advance.

A setting registration screen of FIG. 11 will now be described. FIG. 11 is a diagram illustrating an example of the setting registration screen. The setting registration screen 1101 is a screen displayed on the operation unit 207 of the image processing apparatus 101. The setting registration screen 1101 may be displayed as a webpage on the operation unit of an information processing apparatus such as a PC connected to the image processing apparatus 101 via the network 100. The contents registered from the setting registration screen 1101 are stored in the storage 205.

A connection destination 1102 is a column indicating organization information about connection destinations. A token information 1103 is a column indicating registered token information. An operation button 1104 is a column of operation buttons. Edit buttons 1105 and generation button 1106 are displayed in this item.

If an edit button 1105 is selected, the character strings of the token information and connection destination information can be input or modified using a keyboard. If a generation button 1106 is selected, the scan to chat button 702 is set to be displayed on the home screen 708.

If a new registration button 1107 is selected, an additional connection destination and token information can be registered by accepting character strings input by the user.

Return to the description of the flowchart of FIG. 9.

In step S905, the CPU 202 determines whether channel information is received from the message application server 400 in response to the channel information acquisition request transmitted in step S904. Specifically, if a status code included in the HTTP communication response indicates an error or body information of the response includes a parameter indicating that the information is not acquirable, the CPU 202 determines that channel information is not received. If channel information is determined to be received (YES in step S905), the processing proceeds to step S906. If not (NO in step S905), the processing proceeds to step S917.

In step S917, the CPU 202 displays information indicating that channel information is not successfully received on the channel setting screen 1020. Here, the channel setting screen 1020 does not display any channel option.

In step S918, the CPU 202 determines whether the return button 1023 is selected. If the return button 1023 is determined to be selected (YES in step S918), the processing returns to step S902. If not (NO in step S918), the processing returns to step S918.

In step S906, the CPU 202 displays the channel setting screen 1020 displaying the channel information received from the message application server 400 on the touchscreen 701 of the operation unit 207.

In step S907, the CPU 202 detects whether a channel and a user are finalized by operating the channel setting screen 1020 via the touchscreen 701 of the operation unit 207.

If a channel and a user are finalized (YES in step S907), the processing proceeds to step S908. If not (NO in step S907), the processing returns to step S907.

In step S908, the CPU 202 detects that the summary/character extraction/thumbnail setting button 1004 is pressed. In step S909, the CPU 202 displays the summary/character extraction/thumbnail setting screen 1030 on the operation unit 207.

In step S910, the CPU 202 detects whether the thumbnail settings are finalized by operating the summary/character extraction/thumbnail setting screen 1030 via the touchscreen 701 of the operation unit 207. If the thumbnail settings are finalized (YES in step S910), the processing proceeds to step S911. If not (NO in step S910), the processing returns to step S910.

In step S911, if the monochrome start button 1006 or the color start button 1007 displayed on the operation unit 207 is selected, the CPU 202 reads a document image and generates image data by controlling the reading unit 209 based on the scan settings. The scan settings are specified by the user on the not-illustrated scan to chat detailed setting screen.

In step S912, the CPU 202 generates an image file by converting the image data generated in step S911 into the file format set using the file format button 1011 on the transmission setting screen 1010.

In step S913, the CPU 202 generates a thumbnail image based on the image data generated in step S916 and the format and resolution set on the summary/character extraction/thumbnail setting screen 1030.

In step S914, the CPU 202 generates posting parameters. The posting parameters include information about the posting destination channel, mention user, file format, filename, and message. The file format is the one included in the transmission settings, set using the file format button 1011. The filename is the one specified by the transmission settings.

In step S915, the CPU 202 transmits the image file and the posting parameters generated in steps S912 and S913 to the message application server 400 by the HTTP communication POST method, using the token information registered in advance. When these pieces of data (converted file of the image data, the thumbnail image, and the posting parameters) are transmitted to the message application server 400, the message application server 400 posts the image file and the thumbnail image to the specified channel based on the received parameters. The posting of the image file and the addition of information are performed by the message application server 400.

In step S916, the CPU 202 displays the result of the processing by the message application server 400 on the touchscreen 701 of the operation unit 207.

In such a manner, the user can post the image file and its thumbnail image from the image processing apparatus 101 to the specific channel on the message application server 400.

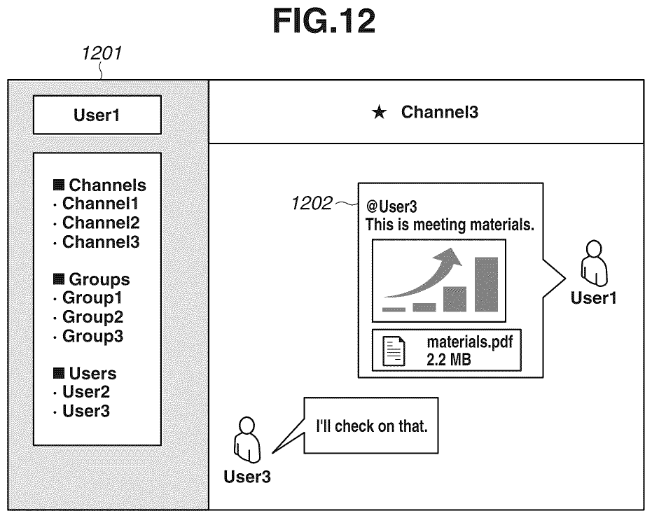

FIG. 12 is a diagram illustrating an example of a message screen of the message application. A message screen 1201 of FIG. 12 is displayed after the message application is activated on the mobile terminal 300 and the series of processes illustrated in FIG. 9 is performed by the image processing apparatus 101. Here, the mobile terminal 300 is communicating with the message application server 400.

When the user activates the message application on the mobile terminal 300 and logs in by inputting the user's account ID and password, a screen dedicated to the user is displayed.

A message 1202 is a chat message displayed when the user with the account user1 posts a message to channel3. The message 1202 is displayed (posted) by the user with the account user1 transmitting an image file generated by scanning and posting parameters to the message application server 400 using the image processing apparatus 101, using the user ID of user1. In the example of FIG. 12, the posting parameters specify “channel3” as the posting channel, “user3” as a mention user, “materials.pdf” as the filename, and “This is meeting materials” as the message.

By performing the foregoing processing, materials.pdf and the thumbnail image of materials.pdf are posted together like the message 1202, whereby the general content of materials.pdf can be figured out without opening the file.

A second exemplary embodiment of the present disclosure will be described below. In the first exemplary embodiment, the thumbnail image is described to be attached with the image file. The second exemplary embodiment deals with an example where optical character recognition (OCR) processing is performed to extract some sentences, and the extracted character strings are transmitted together with the image file.

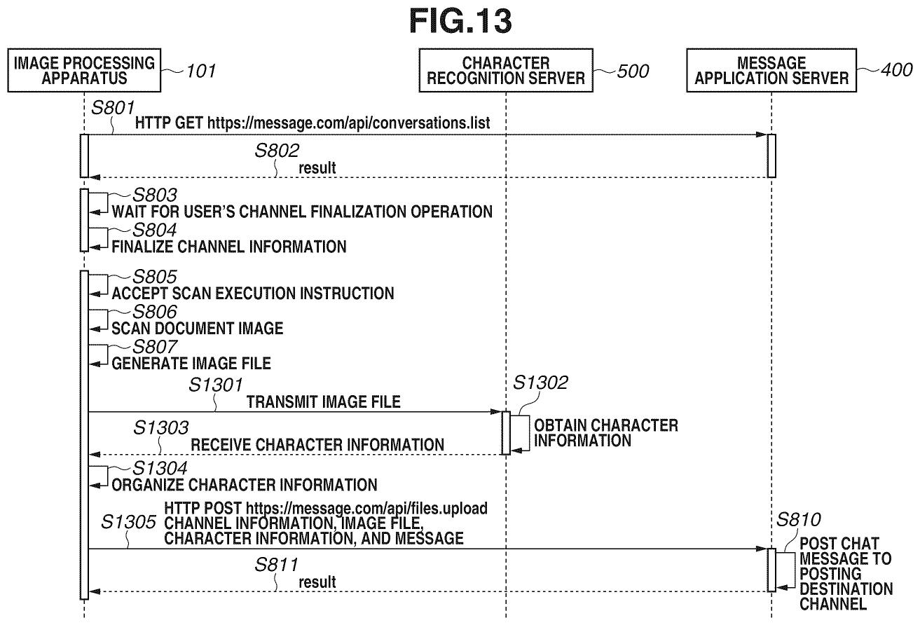

FIG. 13 is a diagram illustrating an example of a sequence where an image processing apparatus 101 extracts some sentences from an OCR result of a file generated by scanning and transmits the extracted character strings to a message application server 400 along with the file.

The processing of steps S801 to S807 is similar to that in FIG. 8. A description thereof will thus be omitted. The example of FIG. 13 deals with a case where character extraction is selected by the send together button 1031 on the summary/character extraction/thumbnail setting screen 1030.

In step S1301, the CPU 202 of the image processing apparatus 101 transmits the image file generated in step S807 to the character recognition server 500 via the communication unit 217 or the wireless communication unit 213. Here, the CPU 202 may transmit setting information about the character extraction, which is set on the summary/character extraction/thumbnail setting screen 1030, to the character recognition server 500. In such a case, the character recognition server 500 performs character recognition and edits the obtained character information as in step S1304 based on the received setting information.

In step S1302, the CPU 501 of the character recognition server 500 performs character recognition processing on the image represented by the image file and obtains character information.

In step S1303, the image processing apparatus 101 receives the obtained character information from the character recognition server 500. The information received here may be text data or document data where the obtained character strings are arranged based on the layout of the image in the image file.

In step S1304, the CPU 202 of the image processing apparatus 101 organizes the character information extracted from the data received in step S1303. This processing is performed based on the character extraction settings set on the summary/character extraction/thumbnail setting screen 1030. Examples include processing for clipping only the first three lines on the first page, and processing for extracting only keywords such as dates, personal names, and titles. If detailed specifications are given at the phase of step S1301 and the character information does not need to be organized, step S1304 may be skipped. Character information is generated by organizing the extracted character information.

In step S1305, the CPU 202 of the image processing apparatus 101 transmits the character information generated in step S1304 to the message application server 400 along with the image file generated in step S807 by HTTP communication via the communication unit 217. Here, the channel information about the posting destination channel and the message are also transmitted.

The processing of steps S810 and S811 is similar to that in FIG. 8. A description thereof will thus be omitted.

While in FIG. 13 the character recognition server 500 is described to perform the OCR processing, the CPU 202 of the image processing apparatus 101 may perform the OCR processing, and transmit the character information in step S1305 using the result of the OCR processing.

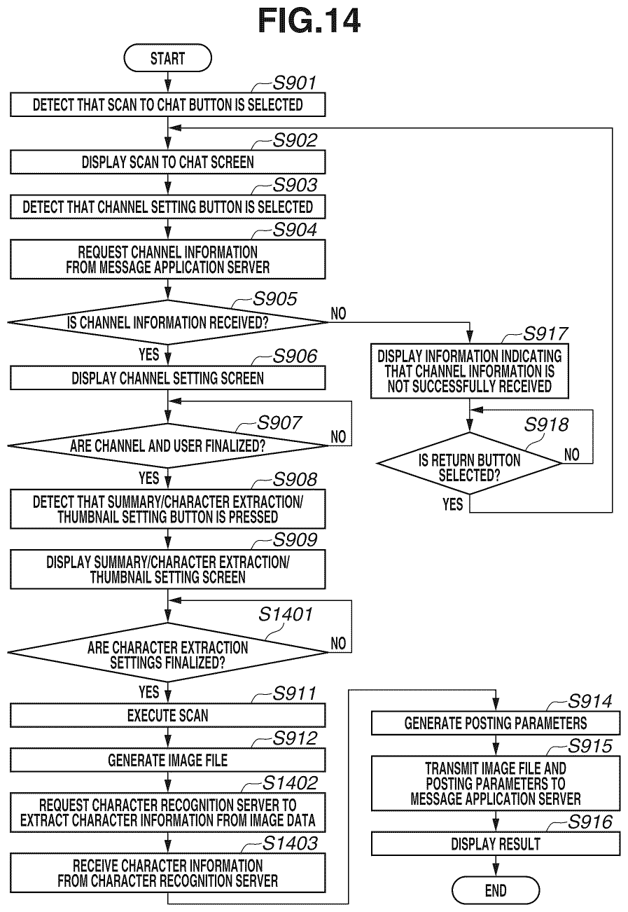

FIG. 14 is a flowchart illustrating an example of the scan to chat processing by the image processing apparatus 101. The processing of the flowchart of FIG. 14 is performed by the CPU 202 reading a program stored in the ROM 203 into the RAM 204 and executing the program.

The processing of steps S901 to S909 is similar to that in FIG. 9. A description thereof will thus be omitted. The present exemplary embodiment deals with an example where character extraction is selected by the send together button 1031 on the summary/character extraction/thumbnail setting screen 1030 displayed in step S909.

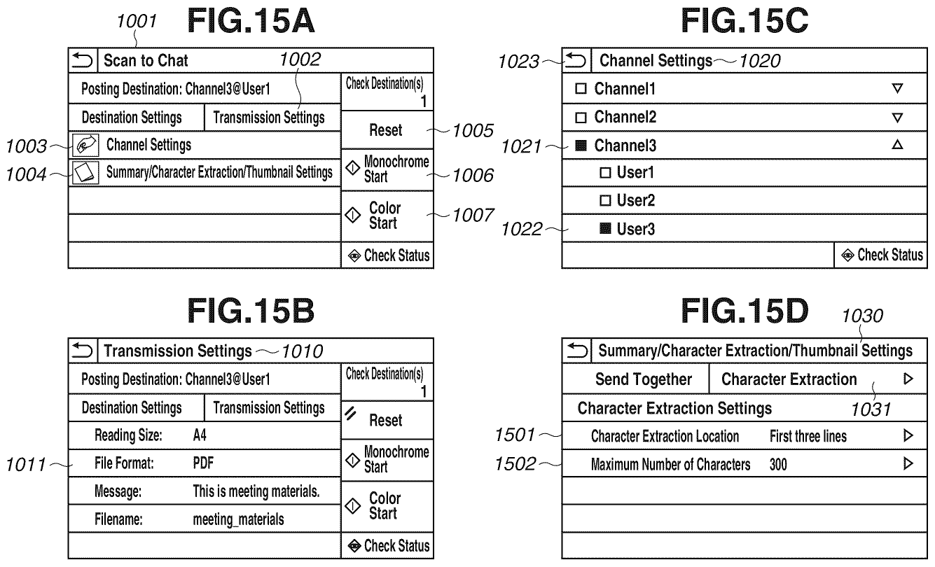

The summary/character extraction/thumbnail setting screen 1030 will now be described with reference to FIG. 15D.

FIG. 15A illustrates an example of the scan to chat screen displayed on the operation unit 207 according to the second exemplary embodiment. The display contents are similar to those of the first exemplary embodiment. A description thereof will thus be omitted.

FIG. 15B illustrates an example of the transmission setting screen displayed on the operation unit 207 according to the second exemplary embodiment. The display contents are similar to those of the first exemplary embodiment. A description thereof will thus be omitted.

FIG. 15C illustrates an example of the channel setting screen displayed on the operation unit 207 according to the second exemplary embodiment. The display contents are similar to those of the first exemplary embodiment. A description thereof will thus be omitted.

FIG. 15D illustrates an example of the summary/character extraction/thumbnail setting screen displayed on the operation unit 207 according to the second exemplary embodiment.

In the first exemplary embodiment, “thumbnail” is described to be selected by the send together button 1031, and the thumbnail settings are described to be displayed. In the second exemplary embodiment, character extraction is selected and a setting screen for character extraction is displayed.

If a character extraction location button 1501 in the character extraction settings is selected, which part of the image represented by the image file to OCR for character recognition and extraction can be selected from options provided in advance. In the example of FIG. 15D, characters in the first three lines are set to be extracted. Other setting options may include to extract characters up to the tenth line from the beginning, and to extract only important items such as dates, personal names, and titles.

If a maximum number of characters button 1502 is selected, the maximum number of characters can be set. In the example of FIG. 15D, the maximum number of characters is set to 300. This setting is a function for avoiding too long a chat message, and the maximum number of characters does not necessarily need to be limited. If the maximum number of characters button 1502 is selected, the user can freely input the number of characters.

While in FIG. 15D the setting items that are the character extraction location and the maximum number of characters are described, the settings related to OCR are not limited thereto. For example, the language to be recognized in the OCR processing may be set. Skew correction may be set to be performed on the scanned image data before the OCR processing. The image of the scanned image data may be displayed on the operation unit 207 so that the user can select the area for the OCR processing.

Return to the description of the flowchart of FIG. 14.

In step S1401, the CPU 202 detects whether the character extraction settings are finalized by operating the summary/character extraction/thumbnail setting screen 1030 via the touchscreen 701 of the operation unit 207. If the character extraction settings are finalized (YES in step S1401), the processing proceeds to step S911. If not (NO in step S1401), the processing returns to step S1401.

The processing of steps S911 and S912 is similar to that of the first exemplary embodiment. A description thereof will thus be omitted.

In step S1402, the CPU 202 of the image processing apparatus 101 transmits the image file generated in step S912 to the character recognition server 500 via the communication unit 217 or the wireless communication unit 213, and requests the character recognition server 500 to extract character information from the image file. If, for example, the area of the OCR processing is set in advance, the information about the area may be transmitted to the character recognition server 500, and the character recognition server 500 may perform the OCR processing based on the received information about the area. In other words, the OCR processing is performed only on the area indicated by the received area information in the image of the received image file. This can reduce the time for the OCR processing.

In step S1403, the CPU 202 of the image processing apparatus 101 receives the character information obtained by the OCR processing of the character recognition server 500 via the communication unit 217 or the wireless communication unit 213.

The character information received here may be text data or document data laid out based on the image of the image file.

In step S914, the CPU 202 generates posting parameters. For example, if the character extraction settings are set to a location extraction location “first three lines” and the maximum number of characters “300”, character information about the first three lines and within 300 characters is extracted (identified) from the character information received in step S1403. If the character information about the first three lines exceeds 300 characters, character information as much as 300 characters may be extracted. Either the character extraction location or the maximum number of characters may be set alone.

Aside from the foregoing extracted character information, the posting parameters include the information about the posting destination channel, the information indicating the mention user, and the message.

In step S915, the CPU 202 transmits the image file and the posting parameters generated in steps S912 and S914 to the message application server 400 by the HTTP communication POST method, using the token information registered in advance. When these pieces of data (the converted file of the image data and the posting parameters) are transmitted to the message application server 400, the message application server 400 posts the image file and the character strings represented by the extracted character information to the specified channel based on the parameters. The posting of the image file and the addition of information are performed by the message application server 400. The processing of steps S916 to S918 is similar to that in FIG. 9. A description thereof will thus be omitted.

In the present exemplary embodiment, the character recognition server 500 is described as being independent from the image processing apparatus 101 and the message application server 400. However, this is not restrictive. For example, the CPU 202 of the image processing apparatus 101 may perform the character recognition processing (OCR processing). The CPU 401 of the message application server 400 may perform the character recognition processing (OCR processing). If the CPU 401 of the message application server 400 performs the character recognition processing, the image processing apparatus 101 transmits the information indicating the character extraction settings to the message application server 400.

The message application server 400 then extracts character information based on the received information indicating the character extraction settings. The message application server 400 then posts the extracted character information and the image file received from the image processing apparatus 101 based on the received posting parameters.

In such a manner, the user can post the image file and the character information (extracted character information therein) obtained by performing the character recognition processing on the image of the image file to a specific channel on the message application server 400.

A third exemplary embodiment of the present disclosure will be described below. In the first exemplary embodiment, the thumbnail image is described to be attached together. In the second exemplary embodiment, the OCR processing is described to be performed, and part of the obtained character information is described to be extracted and transmitted together with the image file. The third exemplary embodiment deals with an example where sentences are summarized using a large language model, and the summary and the image file are transmitted together.

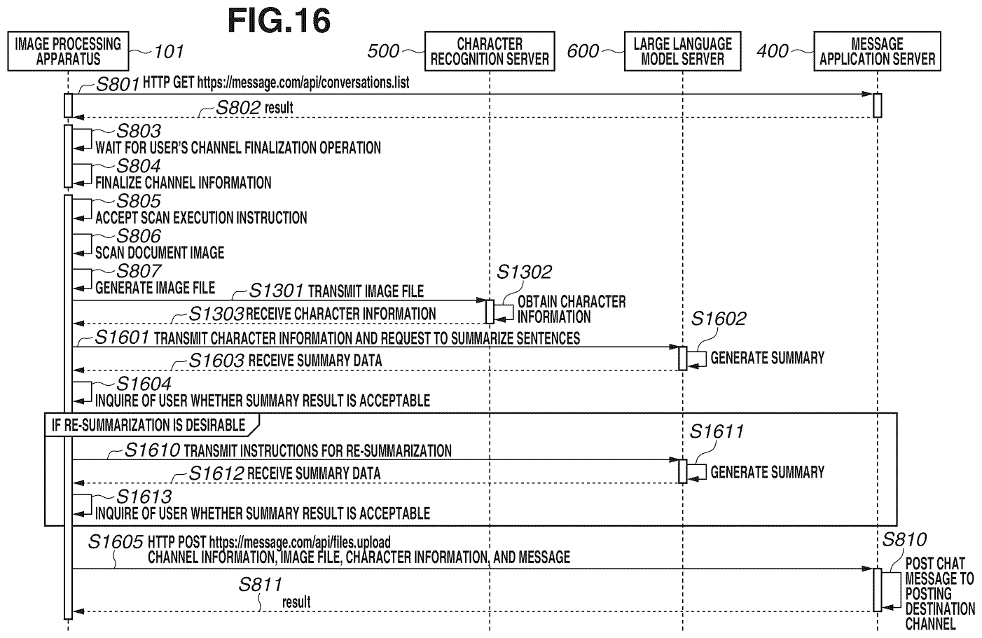

FIG. 16 is a diagram illustrating an example of a sequence where an image processing apparatus 101 transmits a file generated by scanning and a summary generated using the large language model to a message application server 400 together.

Steps S801 to S807 are similar to those of the first exemplary embodiment. A description thereof will thus be omitted. The example of FIG. 16 deals with a case where “summary” is selected by the send together button 1031 on the summary/character extraction/thumbnail setting screen 1030.

In step S1301, the CPU 202 of the image processing apparatus 101 transmits the image file generated in step S807 to the character recognition server 500 via the communication unit 217 or the wireless communication unit 213. The setting information about the character extraction, which is set on the summary/character extraction/thumbnail setting screen 1030, may be transmitted to the character recognition server 500 here. In such a case, the character recognition server 500 performs character recognition and edits the obtained character information as in step S1304 based on the received setting information.

In step S1302, the CPU 501 of the character recognition server 500 performs the character recognition processing on the image represented by the image file and obtains character information.

In step S1303, the image processing apparatus 101 receives the obtained character information from the character recognition server 500. The information received here may be text data or document data where the obtained character strings are arranged based on the layout of the image in the image file.

In step S1601, the CPU 202 of the image processing apparatus 101 transmits the data obtained in step S1303 to the large language model server 600 via the communication unit 217 or the wireless communication unit 213, and requests the large language model server 600 to summarize the sentences. The request transmitted here includes model information and message information. The model information is information indicating which language model to use. The message information includes an item called role, which specifies whose message the message is, and an item called content, which describes instructions that can be written in a natural language. For example, a three-line summary of input sentence data in a bullet list form can be requested by specifying “user” as the roll and “summarize the following sentences in three lines” as the content, and inputting the sentence data. The request transmitted here may include the character information (sentence data) obtained in step S1303 and information indicating summary conditions. The information indicating the summary conditions may be instructions described in a natural language. The request including the information indicating the summary conditions may be transmitted by specifying the URL of a web application programming interface (API). The large language model server 600 may have a character recognition function and perform processing similar to that of the character recognition server 500. In such a case, the image processing apparatus 101 transmits the image file generated by scanning to the large language model server 600.

In step S1602, the large language model server 600 generates summary data based on the character information (sentence data) and the information indicating the summary conditions received in step S1601.

In step S1603, the image processing apparatus 101 receives the generated summary data from the large language model server 600. The response from the large language model server 600 includes “assistant” as the role, with the summary result embedded in the context.

In step S1604, the CPU 202 of the image processing apparatus 101 displays character strings represented by the summary data obtained in step S1603 on the operation unit 207, and inquires of the user whether the summary result is acceptable. If re-summarization is to be performed, the CPU 202 also accepts instructions on how to summarize.

If re-summarization is not needed, then in step S1605, the CPU 202 of the image processing apparatus 101 transmits the image file generated in step S807 and the received summary data to the message application server 400 by HTTP communication via the communication unit 217. Here, the CPU 202 also transmits the information about the posting destination channel and the message. The processing of steps S810 and S811 is similar to that in FIG. 8. A description thereof will thus be omitted.

On the other hand, if re-summarization is to be performed as a result of step S1604, then in step S1610, the CPU 202 of the image processing apparatus 101 transmits instructions for re-summarization to the large language model server 600 via the communication unit 217. The character information to be summarized is already transmitted in step S1601 and stored in the large language model server 600, but may be transmitted again in step S1610.

In step S1611, the large language model server 600 generates summary data based on the character information and the summary conditions received again. In step S1612, the image processing apparatus 101 receives the summary data from the large language model server 600.

In step S1613, the CPU 202 of the image processing apparatus 101 displays the character strings represented by the summary data obtained in step S1610 on the operation unit 207 again, and inquires of the user whether the summary result is acceptable. The CPU 202 can bring the summary result closer to the user's desired outcome by returning to step S1610 to repeat re-summarization again.

In FIG. 16, the character recognition server 500 is described to perform the OCR processing, and the large language model server 600 is described to perform the summarization processing. However, the image processing apparatus 101 may perform the character recognition processing and the summary data generation processing.

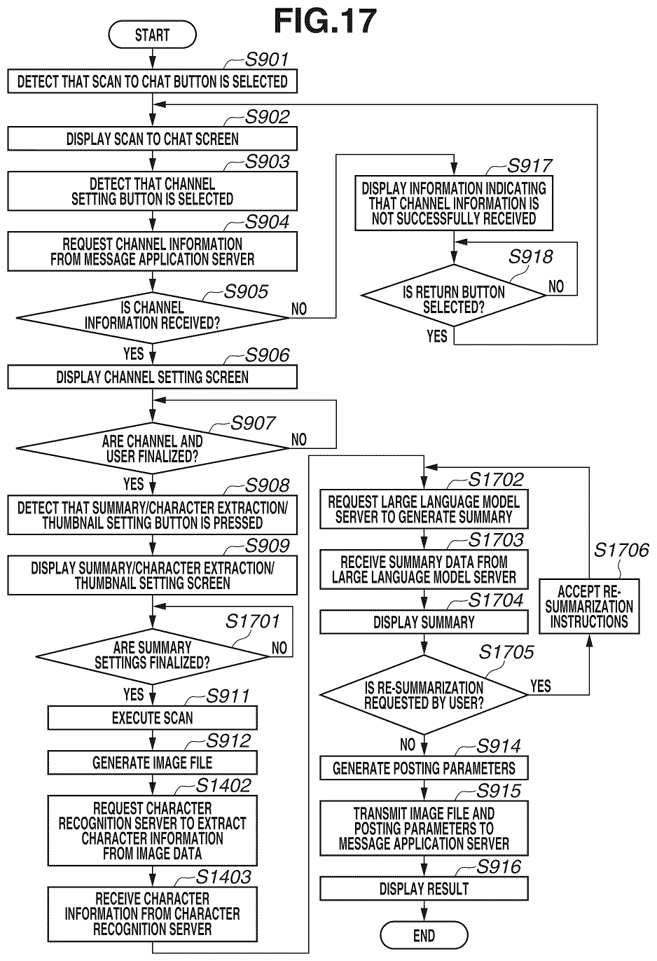

FIG. 17 is a flowchart illustrating an example of the scan to chat processing by the image processing apparatus 101. The processing of the flowchart in FIG. 17 is performed by the CPU 202 reading a program stored in the ROM 203 into the RAM 204 and executing the program.

The processing of steps S901 to S909 is similar to that in FIG. 9. A description thereof will thus be omitted. The present exemplary embodiment deals with an example where “summary” is selected by the send together button 1031 on the summary/character extraction/thumbnail setting screen 1030 displayed in step S909.

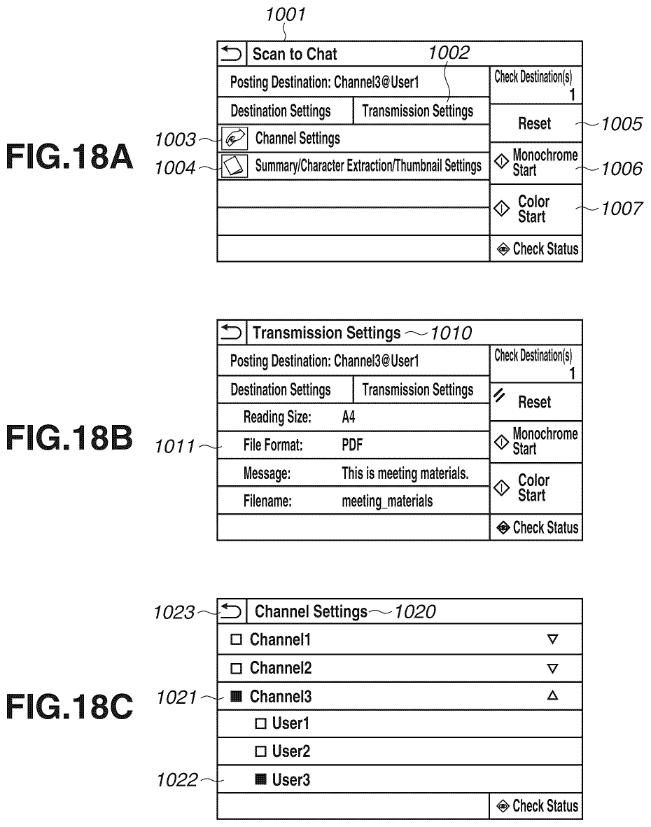

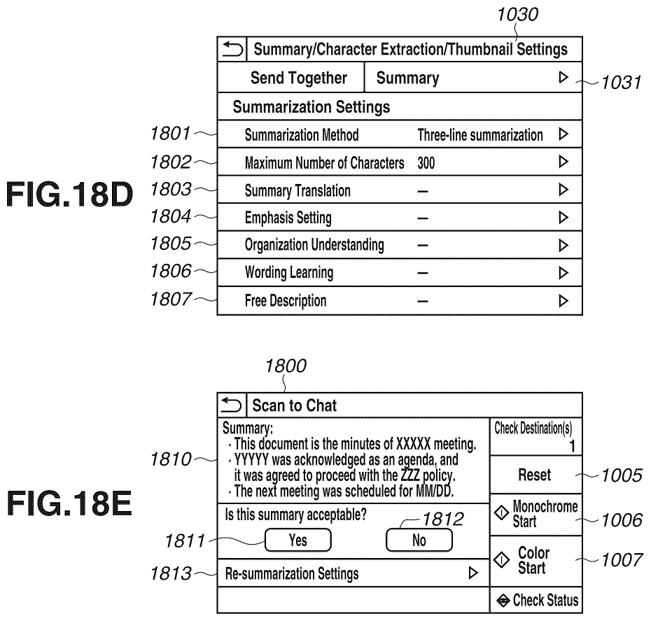

The summary/character extraction/thumbnail setting screen 1030 will now be described with reference to FIG. 18D.

FIG. 18A illustrates an example of the scan to chat screen displayed on the operation unit 207 according to the third exemplary embodiment. The display contents are similar to those of the first exemplary embodiment. A description thereof will thus be omitted.

FIG. 18B illustrates an example of the transmission setting screen displayed on the operation unit 207 according to the third exemplary embodiment. The display contents are similar to those of the first exemplary embodiment. A description thereof will thus be omitted.

FIG. 18C illustrates an example of the channel setting screen displayed on the operation unit 207 according to the third exemplary embodiment. The display contents are similar to those of the first exemplary embodiment. A description thereof will thus be omitted.

FIG. 18D illustrates an example of the summary/character extraction/thumbnail setting screen displayed on the operation unit 207 according to the third exemplary embodiment.

In the second exemplary embodiment, character extraction is described to be selected by the send together button 1031, and the character extraction settings are described to be displayed. In the third exemplary embodiment, “summary” is selected, and a summary setting screen is displayed.

If a summarization method button 1801 is selected, how to summarize the character data can be selected from options provided in advance. In the example of FIG. 18D, three-line summarization is set. Aside from “three-line summarization”, “bullet list” and “not specified” can be set. If “bullet list” is set, the summary is generated in a bullet list form. If “not specified” is set, the summary is generated in a free form.

If a maximum number of characters button 1802 is selected, the number of characters of the summary to be generated can be selected. The image processing apparatus 101 can thus accept a condition on the number of characters of the summary. In the example of FIG. 18D, the maximum number of characters is set to 300. Like the second exemplary embodiment, this setting is merely a function for avoiding too long a chat message, and the number of characters does not necessarily need to be limited.

If a summary translation button 1803 is selected, a request to translate the summary into a desired language can be issued. Translation can further assist the chat message recipient in figuring out the content. For example, if the summary translation button 1803 is selected, a list of languages such as Japanese, English, and Chinese is displayed. The operation unit 207 can accept the user's selection.

If an emphasis setting button 1804 is selected, a request to summarize character data with an emphasis on dates and key points is issued. Emphasis settings can include putting emphasis based on word choice, putting emphasis using symbols, and using heading-level expressions in a markdown output format instead of plain text.

If an organization understanding button 1805 is selected to set an organization understating function ON, settings can be made to obtain organization information stored in the message application server 400 and generate the summary with polite sentences based on the relationship between the partner's position and the sender. The sender here refers to the user corresponding to the user ID transmitted in step S801. The partner refers to the user specified as the mention user. The partner may refer to the users participating in the posting destination channel. In such a case, if the participants in the posting destination channel include at least one user of higher position than the sender, a summary using honorific language is automatically generated. In such a case, the image processing apparatus 101 obtains the organization information from the message application server 400 and conveys the organization information to the large language model server 600. To obtain the organization information, the image processing apparatus 101 communicates with the message application server 400 before step S1601 and obtains the organization information, and then issues the summary instructions in step S1601.

If a wording learning button 1806 is selected to set a wording learning function ON, the image processing apparatus 101 refers to the posting destination channel and has the large language model server 600 learn the wording before issuing the request to generate a summary. This setting enables posting of expressions closer to usual conversations between the sender and the recipient than with the organization information-based settings. Again, in the case of wording learning, the image processing apparatus 101 communicates with the message application server 400 before step S1601 and obtains text information on the channel, and then issues the summary instructions in step S1601.

While the examples of automatically adjusting expressions using the organization understanding button 1805 and the wording learning button 1806 have been described, this is not restrictive. For example, settings such as “honorific language” and “disable honorific language” may be accepted from the user on the summary/character extraction/thumbnail setting screen 1030, and the summary instructions may be issued based on the accepted settings.

If a free description button 1807 is selected, the user can freely input the summarization method using a software keyboard. If the summarization method is set using the free description button 1807, the other setting items may be disabled.

The setting items such as a summarization method, the maximum number of characters, summary translation, emphasis setting, organization understanding, wording learning, and free description have been described with reference to FIG. 18D. However, summary-related settings are not limited thereto. Various items can be freely set without departing from the gist of the present disclosure.

FIG. 18E illustrates an example of a summary result check screen 1800 displayed on the operation unit 207 according to the third exemplary embodiment. The summary result is displayed in an area 1810 after the monochrome start button 1006 or the color start button 1007 is selected to execute a scan and the summarization processing is completed. The user observes this screen and checks the summary result generated by the large language model server 600.

The summary result check screen 1800 displays a yes button 1811 and a no button 1812. The no button 1812 becomes selectable after re-summarization settings are made by selecting a re-summarization setting button 1813. If the re-summarization setting button 1813 is selected, as with the case of the free description button 1807, text input can be accepted using a keyboard. This enables the user to freely give instructions on the summarization method.

Return to the description of the flowchart of FIG. 17. In step S1701, the CPU 202 detects whether the summary settings are finalized by operating the summary/character extraction/thumbnail setting screen 1030 via the touchscreen 701 of the operation unit 207. If the summary settings are finalized (YES in step S1701), the processing proceeds to step S911. If not (NO in step S1701), the processing returns to step S1701.

The processing of steps S911 and S912 is similar to that of the first exemplary embodiment. A description thereof will thus be omitted.

In step S1402, the CPU 202 of the image processing apparatus 101 transmits the image file generated in step S912 to the character recognition server 500 via the communication unit 217 or the wireless communication unit 213, and requests the character recognition server 500 to extract character information from the image file. If, for example, the area of the OCR processing is set in advance, the information about the area may be transmitted to the character recognition server 500, and the character recognition server 500 may perform the OCR processing based on the received information about the area. In other words, the OCR processing is performed only on the area indicated by the received area information in the image of the received image file. This can reduce the time for the OCR processing.

In step S1403, the CPU 202 of the image processing apparatus 101 receives the character information obtained by the OCR processing of the character recognition server 500 via the communication unit 217 or the wireless communication unit 213. The character information received here may be text data or document data laid out based on the image of the image data.

In step S1702, the CPU 202 of the image processing apparatus 101 transmits the character information received in step S1403 to the large language model server 600 via the communication unit 217 or the wireless communication unit 213, and requests the large language model server 600 to generate a summary. Here, the CPU 202 transmits the character information, summary generation instructions, and the information indicating the summary conditions set on the summary/character extraction/thumbnail setting screen 1030 of FIG. 18D to the large language model server 600.

In step S1703, the CPU 202 of the image processing apparatus 101 receives summary data generated by the large language model server 600 via the communication unit 217 or the wireless communication unit 213.

In step S1704, the CPU 202 of the image processing apparatus 101 displays the summary represented by the summary data from the large language model server 600 on the operation unit 207, and inquires of the user whether re-summarization is to be performed.

In step S1705, the CPU 202 of the image processing apparatus 101 determines whether re-summarization is requested by the user. If the user presses the no button 1812 to request re-summarization (YES in step S1705), the processing proceeds to step S1706. On the other hand, if the user presses the yes button 1811 (NO in step S1705), the processing proceeds to step S914.

In step S1706, the CPU 202 of the image processing apparatus 101 accepts the settings configured using the re-summarization setting button 1813 as instructions. The processing returns to step S1702 and starts over at transmitting the summarization request to the large language model server 600.

In step S914, the CPU 202 generates posting parameters. The posting parameters include the foregoing summary data, as well as the information about the posting destination channel, the information indicating the mention user, and the message.

In step S915, the CPU 202 transmits the image file and the posting parameters generated in steps S912 and S914 to the message application server 400 by the HTTP communication POST method, using the token information registered in advance. When these pieces of data (the converted file of the image data and the posting parameters) are transmitted to the message application server 400, the message application server 400 posts the image file and the character strings represented by the summary data to the specified channel based on the received parameters. The posting of the image file and the addition of information are performed by the message application server 400. The processing of steps S916 to S918 are similar to that in FIG. 9. A description thereof will thus be omitted.

In such a manner, the user can post the image file and the summary generated using the large language model from the image processing apparatus 101 to the specific channel on the message application server 400 together.

In the third exemplary embodiment, the character recognition server 500 is described to perform the character recognition processing on the image data (image file) generated by scanning, and the large language model server 600 is described to perform the summary generation processing. However, this is not restrictive. The message application server 400 or another server connected to the message application server 400 may perform the character recognition processing on the image data generated by scanning. The summary generation processing may also be performed by the message application server 400 or another server. In such a case, the image processing apparatus 101 transmits the image data generated by scanning and posting parameters including the information indicating the summary conditions, the summary instructions, and the information about the posting destination information to the message application server 400. The message application server 400 performs the summary generation processing based on the information indicating the summary conditions, included in the received posting parameters. Alternatively, the message application server 400 may delegate the summary generation processing to another server. In such a case, the message application server 400 transmits the information indicating the summary conditions to another server related to the chat service. Note that the servers related to the chat service include a plurality of servers including the message application server 400 and another server. The message application server 400 posts the generated summary and the received image data to the posting destination channel specified by the posting parameters. Even in the case where the message application server 400 performs the character recognition processing and/or the summary generation processing, the summary may be checked via the operation unit 207. For that purpose, the message application server 400 is to transmit the generated summary data to the image processing apparatus 101.

The generated image data and the posting parameters including the summary conditions may be transmitted to another server related to the chat service, not the message application server 400, and another server may transmit the image data and the posting parameters to the message application server 400. Similar applies to the transmission of the posting parameters according to the first and second exemplary embodiments. Another server mentioned above may be a general-purpose server not related to the chat service.

The message application server 400 posts the image data and the summary in the same message, so that which image data the posted summary corresponds to can be clearly seen. In other words, the received image data and the summary are posted in association with each other.

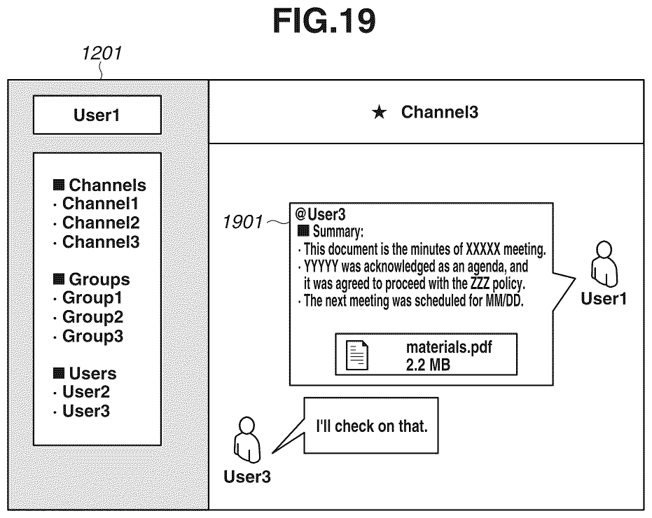

FIG. 19 is a diagram illustrating an example of the message screen of the message application. A message screen 1201 of FIG. 19 is displayed after the message application is activated on the mobile terminal 300 and the series of processes illustrated in FIG. 17 is performed by the image processing apparatus 101.

When the user activates the message application on the mobile terminal 300 and logs in by inputting the user's account ID and password, a screen dedicated to the user is displayed.

A message 1901 is a chat message displayed by the user with the account user1 posting a message to channel3. In the present exemplary embodiment, the message 1901 is displayed (posted) by the user with the account user1operating the image processing apparatus 101 using the user ID of user1 and transmitting the image file generated by scanning and the posting parameters to the message application server 400.

In the example of FIG. 19, the posting parameters specify “channel3” as the posting channel, “user3” as a mention user, and “materials.pdf” as the filename. Since the series of processes in FIG. 17 is performed, three lines of summary generated based on “materials.pdf” are included in the posted comment.

As illustrated in FIG. 19, with materials.pdf and the summary of materials.pdf posted together, the content of the document such as decisions made at the meeting and the date of the next meeting can be seen without opening materials.pdf. Moreover, past chat messages can be searched for by using keywords in the summary results.

The content of a file can be easily checked in uploading the file to the chat service.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-183848, filed Oct. 26, 2023, which is hereby incorporated by reference herein in its entirety.

What is claimed is:

1. An image processing apparatus comprising:
a scan unit configured to scan a document image and generate image data;
an acceptance unit configured to accept setting of a condition to generate a summary based on the image data; and
a transmission unit configured to transmit the generated image data and information indicating the set condition,
wherein the summary generated based on the transmitted information is posted to a channel on a chat service.

2. The image processing apparatus according to claim 1, wherein the condition relates to a number of characters of the summary.

3. The image processing apparatus according to claim 1, wherein the condition relates to an expression in the summary.

4. The image processing apparatus according to claim 3, wherein the transmission unit is configured to transmit the information indicating the set condition to a server related to the chat service.

5. The image processing apparatus according to claim 1, further comprising a reception unit configured to receive the summary from a server that has generated the summary based on the information transmitted by the transmission unit.

6. The image processing apparatus according to claim 5, further comprising a display unit configured to display the received summary.

7. The image processing apparatus according to claim 1, wherein the summary and the image data are posted to the channel by the transmission unit transmitting the image data and the information.

8. The image processing apparatus according to claim 7, wherein the summary and the image data are posted to the channel in association with each other.

9. The image processing apparatus according to claim 1, further comprising a print unit.

10. An image processing method comprising:
scanning a document image and generating image data;
accepting setting of a condition to generate a summary based on the image data; and
transmitting the generated image data and information indicating the set condition,
wherein the summary generated based on the transmitted information is posted to a channel on a chat service.

11. A non-transitory computer-readable storage medium storing a program for causing a computer to perform an image processing method, the image processing method comprising:
scanning a document image and generating image data;
accepting setting of a condition to generate a summary based on the image data; and
transmitting the generated image data and information indicating the set condition,
wherein the summary generated based on the transmitted information is posted to a channel on a chat service.

12. The storage medium according to claim 11, wherein the condition relates to a number of characters of the summary.

13. The storage medium according to claim 11, wherein the condition relates to an expression in the summary.

14. The storage medium according to claim 13, wherein the information indicating the set condition is transmitted to a server related to the chat service.

15. The storage medium according to claim 11, the image processing method further comprising receiving the summary from a server that has generated the summary based on the transmitted information.

16. The storage medium according to claim 15, the image processing method further comprising displaying the received summary.

17. The storage medium according to claim 11, wherein the summary and the image data are posted to the channel by the transmitting of the image data and the information.

18. The storage medium according to claim 17, wherein the summary and the image data are posted to the channel in association with each other.
